(19) United States
(12) Patent Application Publication
(10) Pub. No.: US 2005/0055279 A1
(43) Pub. Date: Mar. 10, 2005

(54) Flexible tax calculation architecture

(75) Inventors: Walter K. Baur, Oxford, CT (US); Christina L. Mattoon, Midlothian, VA (US); Liang Tian, Stamford, CT (US); Hui Fang Ye, Flushing, NY (US)

Correspondence Address: HOFFMAN WARNICK & D'ALESSANDRO, LLC, 3 E-COMM SQUARE, ALBANY, NY, 12207, US

(73) Assignee: International Business Machines Corp., Armonk, NY (US)

(21) Appl. No.: 10/654,665

(22) Filed: Sep. 4, 2003

(51) Int. Cl. G06F 17/60

(52) U.S. Cl. 705/19

(57) ABSTRACT

A system and method for processing tax calculation requests. The method comprises: submitting a tax calculation request to a tax engine in an industry standard format; identifying and resolving customer-specific extensions in the request; selecting one of a plurality of tax calculators to handle the request; translating the request from the industry standard format to a calculator-specific format for the selected tax calculator; and using the selected tax calculator to process the request in the calculator-specific format.

### BACKGROUND OF THE INVENTION

1. Technical Field

The present invention relates generally to tax calculation engine for calculating sales and use tax for the sale of goods and services, and more specifically relates to a callable tax calculation architecture having a standard interface that supports any tax calculation system.

2. Related Art

Accurately calculating sales, use and value added (VAT) tax in a globally distributed environment is a major challenge for all types of businesses. The problem is particularly difficult for ecommerce-based businesses that transact business with customers in many different states and countries. Failure to adhere to local and state tax laws can results in billing errors, undercharging for taxes due, and decreased customer satisfaction.

Presently, there exist numerous tax calculation engines that businesses can utilize to calculate taxes. However, these current solutions have several drawbacks. First, the software for these engines must be updated regularly to keep up to date with changing tax laws. Secondly, the software must often be configured to handle company-specific rules and extensions, e.g., the software may need to know how to legally handle certain types of transactions for the business. These rules must also be updated regularly. Finally, no single available tax engine has worldwide capabilities. Thus, different tax engines must be utilized to handle different international tax calculations, etc.

For instance, U.S. Pat. No. 6,064,983, System for Performing Tax Computations, issued on May 16, 2000, and hereby incorporated by reference, discloses a tax server for modeling the tax interpretation of various insurance and annuity products. The system utilizes a plurality of front-end converters to convert data sent by different user applications into a format required by a back-end tax engine. Unfortunately, this disclosure requires the system to have a unique converter for each different user application, and the converted data is converted to a single message structure for a specific tax engine. Thus, before a business can use the system, a converter must be created to accept data from the business. Moreover, the system does not provide add-on capabilities for additional user-based tax functions not provided by the tax engine.

Accordingly, a need exists for a flexible tax calculation architecture that supports multiple tax engines, add-on capabilities for user-based tax functions, and a standard callable interface that can be used by any business.

### SUMMARY OF THE INVENTION

The present invention addresses the above-mentioned problems, as well as others, by providing a flexible tax calculation architecture that supports multiple tax engines, add-on capabilities for user-based tax functions, and a standard callable interface that can be used by any business. In a first aspect, the invention provides a tax calculation architecture, comprising: an interface for receiving tax calculation requests in an industry standard format; a plurality of tax calculators, wherein each tax calculator includes an interface for receiving calculator-specific requests in a non-industry standard format; and a translator for translating the tax calculation requests from the industry standard format to a format required for one of the plurality of tax calculators.

In a second aspect, the invention provides a program product stored on a recordable medium for processing tax calculation requests, comprising: an interface for receiving tax calculation requests in an industry standard format; and a translator for translating the tax calculation requests from the industry standard format to a format required for one of a plurality of tax calculators, wherein each tax calculator includes an interface for receiving calculator-specific requests in a non-industry standard format.

In a third aspect, the invention provides a method for processing tax calculation requests, comprising: receiving a tax calculation request in an industry standard format at a tax engine; identifying and resolving customer-specific extensions in the request; selecting one of a plurality of tax calculators to handle the request; translating the request from the industry standard format to a calculator-specific format for the selected tax calculator; and using the selected tax calculator to process the request in the calculator-specific format.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a network diagram of a tax engine in accordance with the present invention.

FIG. 2 depicts a diagram of a tax calculation architecture in accordance with the present invention.

FIG. 3 depicts a diagram of a tax engine implemented as a plug-in software solution in accordance with the present invention.

### DETAILED DESCRIPTION OF THE INVENTION

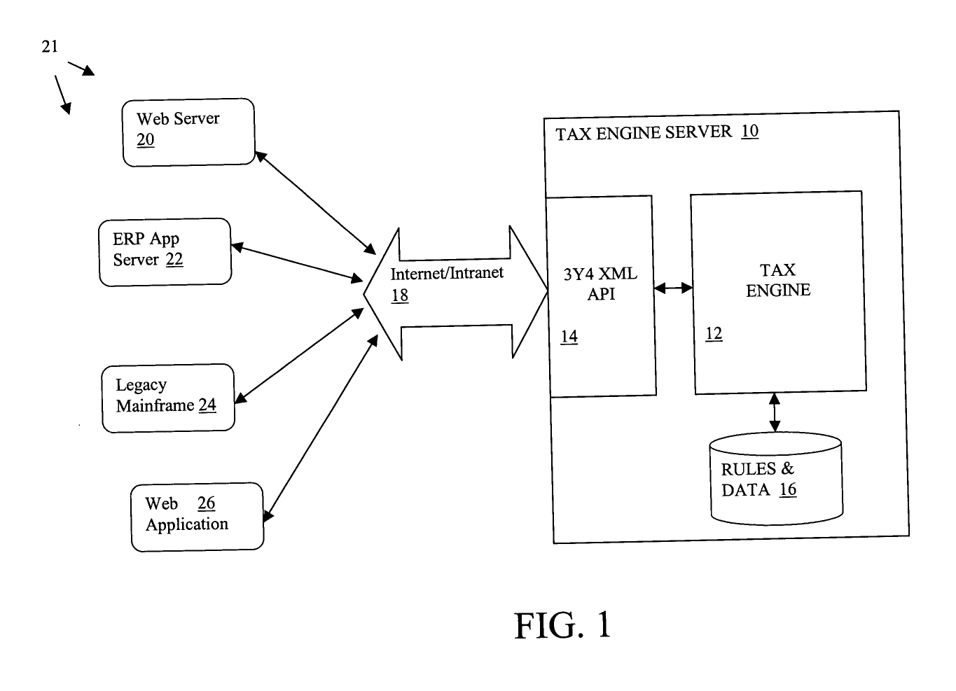

Referring now to the drawings, FIG. 1 depicts a tax engine server 10 implemented as a callable web service. Tax engine server 10 resides on a network 18, such as the Internet or an intranet, such that any business application 21 that has access to the network can submit a “request” for a tax calculation to tax engine server 10. Typical business applications that require tax computations may include a web server application 20 such as IBM's ePRICER™, an ERP application server application 22 such as SAP™, a mainframe application 24, or a point of sale web application such as AMAZON™.

Examples of a “request” may include a request to compute sales tax for a point of sale transaction for a customer living in a particular state, a request by a Business Partner from France to calculate the legally correct tax amount for his sales abroad, a request from corporate internal billing system to verify the tax amount for a particular transaction. The only requirement is that the request must be submitted to the tax engine server 10 in a predefined or industry standard format.

In an exemplary embodiment, the format comprises the industry standard purchase order 3Y4 XML. 3Y4 XML is an IBM™ extended version of RosettaNet 3A4, an XML-based IOS solution with greater compatibility for all companies who have accepted RosettaNet PIPs, which has been established as the de facto industry standard. Benefits of this format include compliance with Business Partner mandates across the industry and inter-organizational architecture standard-settings, as well as ease of implementation. Details of the standard can be found at www.rosettanet.org. However, it should be understood that the invention could be implemented using any predefined schema or format for packaging data transactions, such as a simplified XML or Java Bean.

The exemplary tax engine server 10 shown in FIG. 1 includes a 3Y4 XML application programming interface (API) 14 for receiving the request in a 3Y4 XML format. A partial example of a 3Y4 XML request that recites three basic data elements from a full 3Y4 XML request format is as follows:

1. Ship- to address:
<PurchaseOrder>

<shipTo>

<PartnerDescription>

<PhysicalAddress>

<addressLine1>123 Main Street</addressLine1>

</PhysicalAddress>

</PartnerDescription>

</shipTo>

</PurchaseOrder>
2. Sales amount:
<PurchaseOrder>

<ProductLineItem>

<totalLineItemAmount>

<FinancialAmount>

<MonetaryAmount>4522.22</MonetaryAmount>

</FinancialAmount>

</totalLineItemAmount>

</ProductLineItem>

</PurchaseOrder>
3. Currency:
<PurchaseOrder>

<ProductLineItem>

<totalLineItemAmount>

<FinancialAmount>

<GlobalCurrencyCode>USD</GlobalCurrencyCode>

</FinancialAmount>

</totalLineItemAmount>

</ProductLineItem>

</PurchaseOrder>

The API passes the request to tax engine 12, where the request is processed by one of a plurality of tax calculators, described below. The calculated tax value is then returned through the API 14, across network 18, and back to the requesting business application 21. Tax engine server 10 also includes a database 16 of rules and data, e.g., tax tables, etc., also described below. It is understood that tax engine server 10 can be implemented in any manner. For instance, server 10 may be configured to receive a SOAP request from a client via an HTTP connection over the Internet or intranet. A Java application at the tax engine server 10 can receive the input data from the SOAP servelet, process and format the data, and retrieve other necessary data from a DB2 database 16. As described below, a translator will then convert the data layout into a format required by a selected tax calculator to obtain a calculated tax value, which can be converted back to the 3Y4 XML format and sent back to the client though SOAP.

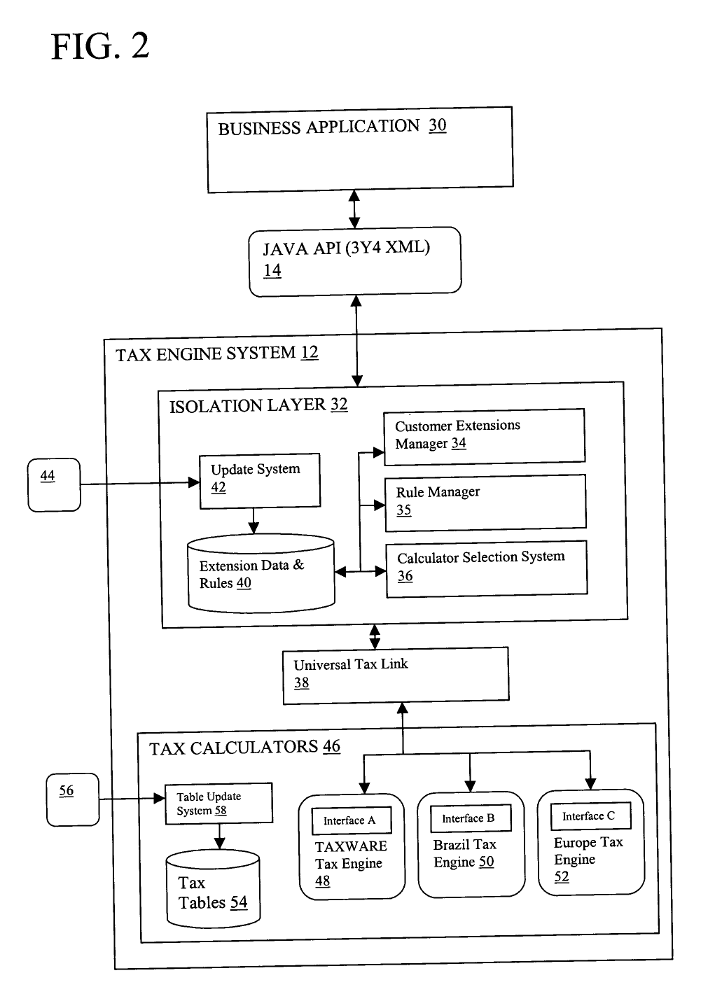

Referring now to FIG. 2, a tax calculation architecture is depicted for implementing a tax engine system 12 in accordance with the invention. As described above, tax engine system 12 communicates with a business application 30 via a predefined API 14, in this case using a Java based 3Y4 XML format. Tax engine system 12 includes a “front-end” isolation layer 32 for receiving requests in the 3Y4 XML industry standard format, and a plurality of “back-end” tax calculators 46 that process data in proprietary, or non-industry standard formats. For the purposes of this disclosure, it is assumed that the reader has a general understanding of the implementation and operation of commercially available tax calculators. Accordingly, specific details about the operation of such systems are not included.

In addition to receiving requests, the isolation layer 32 provides custom business-specific extensions for taxation, as well as a repository 40 for standard and custom taxation rules. Thus, individual businesses can store their extensions at the isolation layer 32 of the tax engine system 12. New and updated extensions and custom rules 44 can be submitted to the isolation layer 32 via an update system 42, which then stores the updates in repository 40.

When a request is received at the isolation layer 32, a rules manager 35 and a custom extension manager 34 process the request. Accordingly, any business specific custom extensions are resolved at the isolation layer 32. Examples of a custom extension may include a maximum taxation calculation at a state, county, and city level; Chicago City tax exemption; a special rule for a restocking fee; special taxing rule for European countries including DOM/TOM (French territories abroad falling under European tax regulation), Taiwan taxation, Brazil taxation, etc. Examples of standard and custom rules include sales use tax at a country, state, county, and city level; particular rules for “Shipping and Handling” tax charges, etc. In addition, isolation layer 32 includes a calculator selection system 36 for selecting one of the plurality of tax calculators 46 to handle the request. The selection of a specific tax calculator may be accomplished using one of the custom or standard rules stored in repository 40. Once a calculator is selected, the request is passed to a universal tax link, which converts the industry standard format request to a format specific to the selected calculator.

In the exemplary embodiment shown in FIG. 2, three tax calculators are provided, which include a TAXWARE™ tax engine 48, a Brazil tax engine 50, and a Europe tax engine 52. Accordingly, the inventive architecture allows for the inclusion of commercially available tax calculators without modification, such as TAXWARE™, existing legacy calculators, custom developed tax engines, etc. The necessary tax tables 54 can be stored in a single location with the calculators 48, 50, 52 and receive updates 56 via a table update system 58. Moreover, because any custom extensions are isolated in a layer above the tax calculators, duplication is avoided and consistent and accurate tax calculations are ensured.

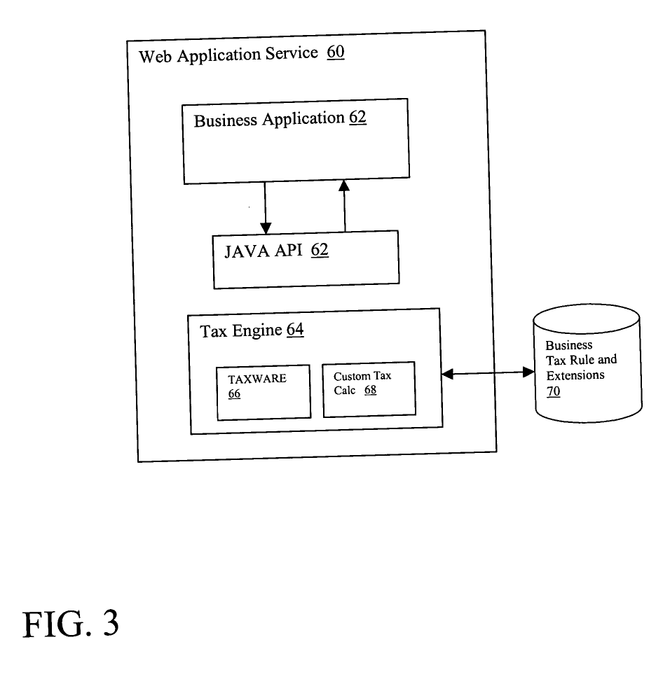

FIG. 3 depicts a further exemplary embodiment, in which the tax engine 64 has been incorporated as a plug-in software component. In this case, a Java API 62 is provided through which one or more business applications can invoke the functionality of the tax engine 64. Similar to the examples disclosed above, the tax engine 64 may include multiple tax calculators, e.g., TAXWARE™, a custom tax calculator 68, etc. After the tax engine 64 receives the input data in a standard, predefined format (such as 3Y4 XML) through the Java API 62, the data is processed and formatted into an acceptable format for a selected tax calculator. In addition, related data and rules are retrieved from a database 70. After the tax value is calculated, the data containing the value can be messaged by business rules and sent back to the business application 62.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A tax calculation architecture, comprising:
an interface for receiving tax calculation requests in an industry standard format;
a plurality of tax calculators, wherein each tax calculator includes an interface for receiving calculator-specific requests in a non-industry standard format; and
a translator for translating the tax calculation requests from the industry standard format to a format required for one of the plurality of tax calculators.

2. The tax calculation architecture of claim 1, further comprising an isolation layer residing between the interface and the plurality of tax calculators, wherein the isolation layer includes:
a database for storing customer-specific extensions and rules;
a customer extension manager for interpreting and managing customer-specific extensions; and
a system for selecting one of the plurality of tax calculators.

3. The tax calculation architecture of claim 2, wherein the tax calculator is selected based on a rule defined the in the database.

4. The tax calculation system of claim 1, wherein the industry standard format comprises 3Y4 XML.

5. The tax calculation system of claim 1, wherein at least one of the tax calculators is for a specific geographic region.

6. The tax calculation system of claim 1, further comprising an update system for updating customer-specific extensions and rules.

7. The tax calculation system of claim 1, wherein the interface for receiving tax calculation requests is callable via a network.

8. A program product stored on a recordable medium for processing tax calculation requests, comprising:
an interface for receiving tax calculation requests in an industry standard format; and
a translator for translating the tax calculation requests from the industry standard format to a format required for one of a plurality of tax calculators, wherein each tax calculator includes an interface for receiving calculator-specific requests in a non-industry standard format.

9. The program product of claim 8, further comprising an isolation layer residing between the interface and the plurality of tax calculators, wherein the isolation layer includes:
a database for storing customer-specific extensions and rules;
a customer extension manager for interpreting and managing customer-specific extensions; and
a system for selecting one of the plurality of tax calculators.

10. The program product of claim 9, wherein the selection of the tax calculator is based on a rule defined the in the database.

11. The program product of claim 8, wherein the industry standard format comprises 3Y4 XML.

12. The program product of claim 8, wherein at least one of the tax calculators is for a specific geographic region.

13. The program product of claim 8, further comprising an update system for updating customer-specific extensions and rules.

14. The program product of claim 8, wherein the interface for receiving tax calculation requests is callable via a network.

15. A method for processing tax calculation requests, comprising:
receiving a tax calculation request in an industry standard format at a tax engine;
identifying and resolving customer-specific extensions in the request;
selecting one of a plurality of tax calculators to handle the request;
translating the request from the industry standard format to a calculator-specific format for the selected tax calculator; and
using the selected tax calculator to process the request in the calculator-specific format.

16. The method of claim 15, wherein the tax engine resides on a computer network.

17. The method of claim 15, wherein the selection of the tax calculator is based on a rule stored in a rules database.

18. The method of claim 17, wherein the selection of the tax calculator is based on a geographic requirement.

19. The method of claim 15, wherein the industry standard format comprises 3Y4 XML.
